(19) United States
(12) Patent Application Publication
(10) Pub. No.: US 2008/0244263 A1
(43) Pub. Date: Oct. 2, 2008

(54) Certificate management system

(75) Inventor: Rolf Lindemann, Stelle (DE)

Correspondence Address: WILMERHALE/BOSTON, 60 STATE STREET, BOSTON, MA, 02109, US

(73) Assignee: TC Trust Center, GmbH, Hamburg (DE)

(21) Appl. No.: 11/729,735

(22) Filed: Mar. 29, 2007

(51) Int. Cl. H04L 9/00

(52) U.S. Cl. 713/158

(57) ABSTRACT

A system and method for generating and storing a large number of public key certificates that enables a revocation status to be determined while providing a smaller amount of storage than is typically required.

### BACKGROUND

A public key digital certificate is a token that typically includes at least the following properties: (1) a starting validity date and time; (2) a defined validity period of the token; (3) a unique identifier, typically a serial number and an issuer identifier; and (4) an associated revocation state. In other words, a certificate has information that identifies who issued it, what its serial number is, when it starts, and how long it lasts. These items of data do not change, and thus are static. The revocation state, however, can change from a valid state to a not valid state while the duration information would indicate the certificate is valid. The revocation state usually cannot be derived from the certificate itself. The most widely used certificate is a type defined in RFC-2459, and RFC-3280.

A typical current certificate management systems, known as a certificate authority (CA), uses database systems to store the information regarding each certificate and the certificate itself separately in a database. Typically, there is one database row per certificate containing the relevant data fields as database columns. Storage with these fields leads to a basic data complexity of N, where N denotes the number of certificates. Usually the CA system also maintains revocation information, often stored as a separate database with a column linked to particular database rows for the certificates.

### SUMMARY

The systems and methods described here can provide a more efficient combination of a certificate authority and a validation service for exploring whether a particular certificate has been issued, a revocation state (RS) associated with a current certificate, and possibly a date associated with a revocation. The system described here provides such a validation service that can provide revocation data, and also provide an affirmative confirmation that a certificate is valid, with reduced data complexity, i.e., a reduced number of data items to be stored for a given number of certificates. The systems and methods described here can have a data complexity based on a number of significant time intervals per a given issuer identifier. This system can be used for very large numbers of certificates, e.g., more than 100,000 or even more than 1,000,000 or 10,000,000 certificates. The system can be used with standard CRL or OCSP protocols.

Other features and advantages will become apparent from the following detailed description, drawings, and claims.

### BRIEF DESCRIPTION OF THE DRAWINGS

FIG. 1 is a block diagram illustrating a prior art system in which certificate data has been stored.

FIG. 2 is a block diagram illustrating an embodiment of a system and method of storing certificate information as described in the description.

### DETAILED DESCRIPTION

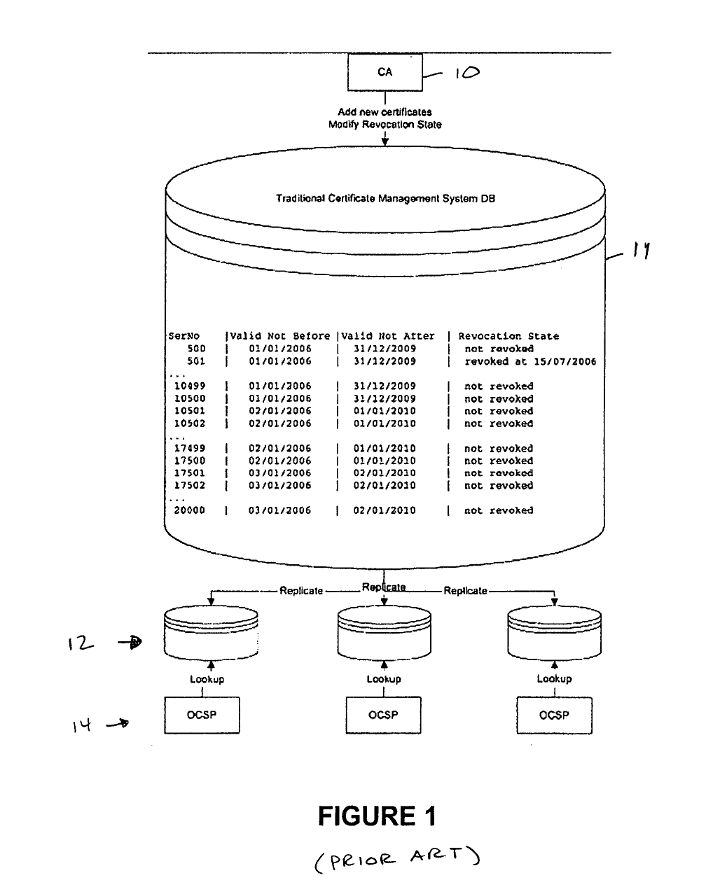

FIG. 1 represents a known prior art system in which there is a typical known certificate authority (CA) 10 that issues new certificates and modifies a revocation state of those certificates. The certificate data is held in a certificate management system database 11 and includes the following fields: Serial Number (SerNo), Valid Not Before, Valid Not After, and Revocation State (RS). This data needs to be accessed frequently as transactions are taking place over the Internet. To help make this information available, the revocation data is replicated across a number of databases 12. These databases 12 can be accessed by an online certificate status protocol (OCSP) 14. An OCSP is an Internet protocol used for obtaining the revocation status of an X.509 digital certificate and is described in RFC 2560.

OCSP is one method for providing information to allow others to determine the revocation state of the certificate. An example of such a system is described in German application DE 100 61 102, which is incorporated herein by reference. OCSP is an alternative to another approach for identifying revoked certificates, known as a certificate revocation list (CRL). With OCSP, revocation state data can be accessed with less substantial data transfer than is typically required with CRL systems.

As indicated in FIG. 1, there is a separate row of data for every certificate as identified by serial number. Such storage can be efficient and effective with thousands or even tens of thousands of certificates. However, certificates could be issued in large quantities for use in consumer devices, such as set top boxes, and in some places to individuals on a large scale. For example, Germany is implementing a health care system in which everyone will receive a health card, and each health card would have a digital certificate. Such systems could result in tens of millions of certificates being issued (60-80 million for health cards in Germany, for example), thereby creating very expensive database costs.

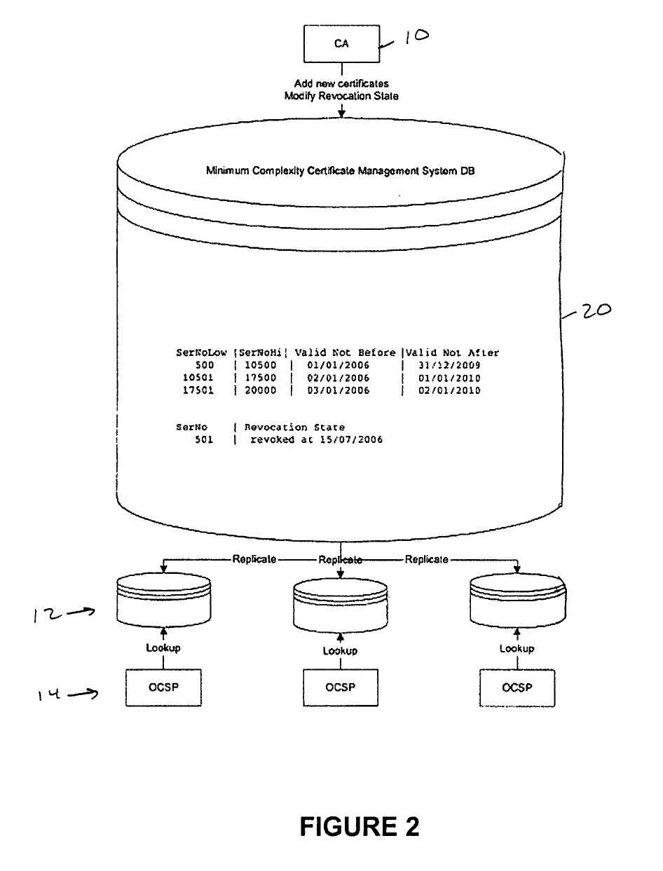

Referring to FIG. 2, in this system, the replicated databases, and OSCP can be substantially similar to those in prior art FIG. 1. A certificate authority 21 issues groups of certificates that share common duration information, e.g., the same start and end date of validity (“Valid Not Before” and “Valid Not After”), instead of setting these values different for each certificate and using consecutive serial or sequential numbers. The certificate management system database 20 also stores certificate information in a different manner from database 11 (FIG. 1). The system includes applicable interfaces and hardware, such as general purpose programmed processors, specific purpose processors, or other logic for storing information, looking up data, retrieving data, and providing interfaces. Aspects of the system can be implemented in software with instructions stored on a computer readable medium, such as a disk, memory stick, or other memory that can store software.

In this system, there is a reduced complexity certificate management system database in which ranges of serial numbers (from SerNoLow to SerNoHigh) are grouped together based on common valid duration information, shown here as “Valid Not Before” (start) dates, and “Valid Not After” (end) dates that are stored persistently. A separate list sets out the serial numbers that have a revocation state that is something other than valid or “not revoked.”

For simplicity, it is assumed that the issuer identifier (IID), e.g., the certificate authority, is identical for all certificates in this section. If multiple IIDs are to be supported in the system, the database system (e.g., tables within a database or separate database) can be replicated for each IID. The certificate issuance system usually is assumed to write audit data regarding each issued certificate. Since the validation service does not need to access these data, this audit data is not considered relevant for the data complexity.

The data could be stored with other parameters or with the same parameters with different names. The duration information could be based on Valid Not Before and Validity Period fields, rather than Valid Not After. The storage does not need to be a database; the information could be stored in any suitable form of memory for storing the information.

Optionally, the serial number data for certificates can be encoded/encrypted. For example, for millions of health cards, each can have a coded number (which could include numerals or letters). This coded number would typically be provided in a machine readable format only, e.g., on a magnetic stripe, although it could possibly be printed on the card. This coded serial number would have no apparent relation to any other serial number unless it were decoded. For example, one could not tell that two certificates had consecutive serial numbers when the numbers are coded.

The following example illustrates a validation process, using a card with a certificate as an example, although other types of transactions would work similarly. When the card is presented for a transaction, e.g., a pharmaceutical purchase in case of a health card system, the coded serial number and issuer identifier are read by machine and provided to an issuer's validation system. The validation system receives the coded serial number and converts the coded serial number to an internal serial number, e.g., a sequential serial number. The system uses the serial number to look up in the database an entry matching the given issue identifier and where the requested serial number is contained in a range of serial numbers. For example, a serial number of 6001 might be represented in a row with serial numbers 5000-9999, which all have a common valid duration (e.g., stop and start date). It could be the case that all serial numbers in that range have been revoked. In that case, that answer (revoked) is returned by the system. In other cases, it could be that the serial number range of 5000-9999 is a valid (not revoked) range. In that case, the system checks a separate revocation list to see if the particular serial number (e.g., 6001) is on the revoked list. If yes, the answer returned is that the certificate is revoked, and if not, a valid answer is returned. The acts of checking the revocation list and the general serial number list could be done in either order.

One characteristic of this system is the ability to affirmatively determine that a certificate with a certain serial number is valid, i.e., if it is identified as being in a valid range and not one of the revoked certificates. The individual information associated with certificates could indicate other forms of “not valid” in addition to revoked, e.g., suspended.

In case a certificate revocation list (CRL) is to be generated, every certificate with a non-final revocation state different from the default revocation state (e.g., a not revoked default state) is identified by an appropriate entry in a database. This entry is deleted if the state is changed back to the default revocation state or if it is changed to a final revocation state. Every certificate with a final revocation state is identified by an entry in the database until it is included in a CRL the first time. Then it is identified by an entry in the CRL(s) only to keep the database small. The recommendation is to store entries representing a non-final revocation state at the end of the CRL preceded by the new final state entries, i.e., the ones that come from the temporary database entries and appear the first time in a CRL. Doing this, the application maintaining the CRL is not required to read-in the whole current CRL when generating the new one. It could simply start appending entries at the (file) location after the last final state entry remembered from generating the last CRL. CRL processing applications (e.g., validation systems) could also remember the offset of the last entry which has already been added to the internal memory. Only the remaining entries would have to be added. The Delta-CRL can be generated. Only (all) the entries with a non-final revocation state the new entries with non-default revocation state stored in the database have to be taken. In a system compliant to RFC2459 and RFC3280, a state transition from suspended to revoked will not change the RS date. This will most likely be a single entry per certificate as compared to a block. This list of revoked certificates may have different internal representations, e.g. sequential lists, hash-trees, or B-trees, although referred to as a CRL in this document.

One example that is mentioned here is a health card, but other applications can benefit from such a system, e.g., device certificates. In such an environment, millions of devices, such as set top boxes, can be equipped with certificates for transactions done over networks. The revocation processing time will likely not be critical.

It should be apparent that modifications can be made without departing from the scope of the invention as defined by appended claims. For example, as indicated previously, while the memory has been described in terms of a database, other forms of memory could be used because of the reduced need for data. While certain examples of certificates have been described, other certificates can be used and the data can be stored with fields that vary somewhat from those described above, although it would typically be required that some field indicate the time during which the certificate is valid and not revoked and some identifier for the certificate. The certificates have been described as being consecutively numbered; such consecutive numbering could be by ones, but could also be by twos or tens or some other regular periodic system. The data is described as being in “rows” but this terminology should be understood to include any method in which data is organized and where data can be associated with other data; whatever the means, what is desired is for a number of certificates to be able to be grouped, e.g., in a consecutive range, and associated with common valid duration information, allowing the memory to group certificates and not require an individual entry for every certificate. All certificates with common duration information can be stored in one row, but significant savings in storage can be obtained even if multiple groups of certificates, each with common valid duration information, are stored in several different rows.

What is claimed is:

1. A system comprising:
a certificate authority system for issuing certificates, each certificate including valid duration information indicating a period when the certificates are valid and individual identification information, the system including
first memory for storing information about digital certificates in rows, wherein each of a plurality of rows has a range of identification numbers with common valid duration information, such that one row has a first range of identification information with common validity duration information and a second row has a second range of identification, different from the first range of information, having common valid duration information different from the valid duration information for the first row,
second memory including information indicating, for a subset of the certificates, that such certificates is not valid and an associated date.

2. The system of claim 1, wherein the first memory includes at least 100,000 certificates.

3. The system of claim 1, wherein the first memory includes at least 1,000,000 certificates.

4. The system of claim 1, wherein the first memory includes at least 10,000,000 certificates.

5. The system of claim 1, wherein the duration information includes a valid start date and an end date.

6. The system of claim 1, wherein the duration information includes a start date and a valid period.

7. The system of claim 1, wherein the first memory and second memory are separate tables in a single physical memory.

8. The system of claim 1, wherein the identification information includes serial numbers issued consecutively.

9. The system of claim 8, further comprising a decoder for receiving and decoding a coded serial number, the decoder producing a decoded serial number, wherein the decoded serial numbers can be arranged consecutively based on when the certificates with those serial numbers were issued, wherein the coded serial number obscures when one certificates was issued relative to another.

10. The system of claim 1, further comprising processing logic, responsive to a request with identification information, for looking up the identification information in the first memory and second memory and returning information on whether the certificate is valid.

11. The system of claim 10, wherein the processing logic includes a decoder for receiving and decoding identification information, the decoder producing a decoded serial number, wherein the decoded serial numbers can be arranged consecutively based on when the certificates with those serial numbers were issued, wherein the coded serial number obscures when one certificates was issued relative to another.

12. A method for validating a digital certificate comprising:
receiving data identifying a certificate;
storing information about digital certificates in memory, including:
first memory for storing information about digital certificates in rows, wherein each of a plurality of rows has a range of identification numbers with common valid duration information, such that one row has a first range of identification information with common validity duration information and a second row has a second range of identification, different from the first range of information, having common valid duration information different from the valid duration information for the first row, and
second memory including information indicating, for a subset of the certificates, that such certificates is not valid and an associated date;
looking up the certificate based on the data in a first memory;
looking up the certificate based on the data in a second memory;
based on the looking up processes, identifying to a requester whether the certificate is valid or not valid.

13. The method of claim 11, wherein the received data is in coded form, the method further including decoding the received data to derive a sequential serial number.

14. The method of claim 11, wherein the storing includes storing information related to least 1,000,000 certificates in first memory.

15. The method of claim 11, wherein the storing includes storing information related to at least 10,000,000 certificates in first memory.

16. The method of claim 11, wherein the storing includes storing with duration information including a valid start date and an end date.

17. The method of claim 11, wherein the storing includes storing with duration information including a start date and a valid period.

18. The method of claim 11, wherein the storing includes storing in a database, the first memory and the second memory being part of the same database.

19. The method of claim 11, wherein the looking up in second memory is performed before looking up in first memory.

20. The method of claim 11, wherein the looking up in first memory is performed before looking up in second memory.

21. A computer readable medium having instructions that, when executed, perform the method of claim 11.
